(19) United States
(12) Patent Application Publication
(10) Pub. No.: US 2021/0033995 A1
(43) Pub. Date: Feb. 4, 2021

(54) LIQUID DEVELOPER AND IMAGE-FORMING APPARATUS

(71) Applicant: CANON KABUSHIKI KAISHA, Tokyo (JP)

(72) Inventors: Yuzo Tokunaga, Chiba-shi (JP); Tomoyo Miyakai, Tokyo (JP); Takashi Hirasa, Moriya-shi (JP); Hayato Ida, Toride-shi (JP); Yasutaka Akashi, Yokohama-shi (JP)

(21) Appl. No.: 16/936,250

(22) Filed: Jul. 22, 2020

(30) Foreign Application Priority Data
Jul. 30, 2019 (JP) 2019-140185

(51) Int. Cl. G03G 9/125

(52) U.S. Cl. CPC G03G 9/125; G03G 2215/0629

(57) ABSTRACT

A liquid developer contains toner particles containing a binder resin and a colorant, a liquid carrier, a toner-particle dispersant, and a compound represented by formula (1). The liquid carrier contains at least one selected from the group consisting of liquid aliphatic hydrocarbons and liquid polysiloxanes. The toner-particle dispersant is an amine-based dispersant.

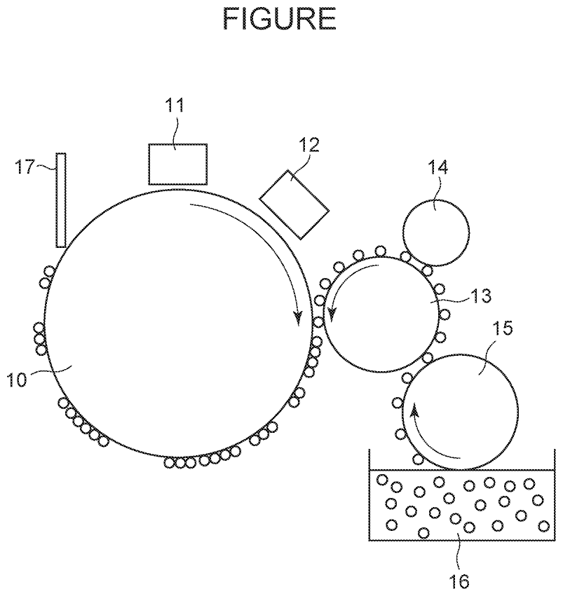

### BACKGROUND OF THE INVENTION

### Field of the Invention

The present disclosure relates to a liquid developer used for an image-forming apparatus (what is called an electrophotographic apparatus) using electrophotography and an image-forming apparatus.

### Description of the Related Art

Electrophotography is a method for forming an image, the method including charging a surface of an electrophotographic photosensitive member (charging step), irradiating the surface of the electrophotographic photosensitive member with image exposure light to form an electrostatic latent image (image exposure step), developing the electrostatic latent image with a developer containing toner particles to form a toner image (development step), transferring the toner image to a recording medium, such as paper or a plastic film (transferring step), and fixing the transferred toner image to the recording medium (fixing step).

Developers are broadly categorized into a dry developer in which toner particles containing a binder resin and a colorant are used in a dry state and a liquid developer containing a liquid carrier and toner particles containing a binder resin and a colorant. Typically, electrical insulating liquids are used for liquid carriers for liquid developers.

In recent years, there has been an increasing need for higher image quality and high-speed printing for electrophotographic devices, such as light printing devices, copiers, and printers.

To meet the need, liquid development methods with liquid developers are advantageous. The reason for this is that fine toner particles can be used because liquid developers are less likely to lead to aggregation of toner particles during storage. Thus, the use of liquid development methods results in excellent reproducibility of thin-line images and images having excellent tone reproducibility.

In liquid development methods, toner particles in liquid developers are charged, and then the charged toner particles are subjected to electrophoresis in liquid carriers to develop electrostatic latent images. The use of a charge-controlling agent is known as one of the methods for efficiently subjecting toner particles to electrophoresis.

Japanese Patent Nos. 3442406, 6129144, and 3267716 disclose techniques using lecithin as a charge-controlling agent. Japanese Patent Nos. 3442406 and 3267716 disclose techniques using barium sulfonate-based charge-controlling agents, such as barium petronate.

To improve the dispersibility of toner particles, toner-particle dispersants are sometimes used in liquid developers containing toner particles. Japanese Patent No. 5148621 discloses that a dispersant having a basic polar group can be used as a toner-particle dispersant.

However, charge-controlling agents and toner-particle dispersants typically contain a large number of ionizable polar groups in their chemical structures and are likely to cause a decrease in the electrical resistance of liquid developers. In the case where the electrical resistance (volume resistivity) of such a liquid developer is decreased, an electric field is less likely to be applied in a development step and a transfer step, thereby causing disadvantages, such as decreases in the electrophoretic properties of toner particles and the developability of electrostatic latent images. In the case where such a disadvantage arises, dot reproducibility deteriorates easily.

### SUMMARY OF THE INVENTION

One aspect of the present disclosure is directed to providing a liquid developer that has a high electrical resistance (volume resistivity) and that contains toner having excellent electrophoretic properties.

Another aspect of the present disclosure is directed to providing an image-forming apparatus that can form a high-quality electrophotographic image.

One aspect of the present disclosure is directed to providing a liquid developer containing toner particles containing a binder resin and a colorant, a liquid carrier, a toner-particle dispersant, and a compound represented by formula (1), the liquid carrier containing at least one selected from the group consisting of liquid aliphatic hydrocarbons and liquid polysiloxanes, the toner-particle dispersant being an amine-based dispersant:

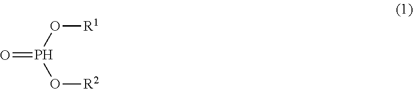

where in formula (1), R¹ and R² are each independently an alkyl group having 6 to 20 carbon atoms.

Another aspect of the present disclosure is directed to providing an image-forming apparatus including an electrophotographic photosensitive member and a liquid developer that develops an electrostatic latent image to be formed on the electrophotographic photosensitive member, the liquid developer containing toner particles containing a binder resin and a colorant, a liquid carrier, a toner-particle dispersant, and a compound represented by formula (1), the liquid carrier containing at least one selected from the group consisting of liquid aliphatic hydrocarbons and liquid polysiloxanes, the toner-particle dispersant being an amine-based dispersant:

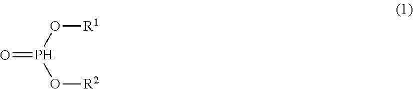

where in formula (1), R¹ and R² are each independently an alkyl group having 6 to 20 carbon atoms.

Further features of the present disclosure will become apparent from the following description of exemplary embodiments with reference to the attached drawing.

### BRIEF DESCRIPTION OF THE DRAWINGS

FIGURE illustrates an example of an image-forming apparatus (electrophotographic apparatus) including a liquid developer according to an embodiment of the present disclosure.

### DESCRIPTION OF THE EMBODIMENTS

In the present disclosure, the expression “XX or more and YY or less” or “XX to YY” indicating a numerical range refers to a numerical range including the lower limit and the upper limit, which are end points, unless otherwise specified.

The liquid developer according to an embodiment of the present disclosure contains toner particles containing a resin binder and a colorant, a liquid carrier, and a toner-particle dispersant. The liquid developer further contains a compound represented by formula (1). The compound represented by formula (1) is a type of ester compound of phosphonic acid with alcohol and acts as a charge-controlling agent.

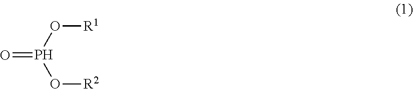

In formula (1), R¹ and R² are each independently an alkyl group having 6 to 20 carbon atoms.

The compound represented by formula (1) has a smaller number of ions per molecule than a zwitterionic polymer compound, such as lecithin, used as a charge-controlling agent in the related art and thus is less likely to cause a decrease in the electrical resistance of the liquid developer. Additionally the compound represented by formula (1) effectively functions as a charge-controlling agent when an amine-based dispersant is used as a toner-particle dispersant.

The reason for this will be described below.

Phosphate ions of the compound represented by formula (1) adsorb easily on ammonium ions (cations) of the amine-based dispersant adsorbed on surfaces of the toner particles under a weak or no electric field. Thus, the compound represented by formula (1) is likely to be present on the surfaces of the toner particles.

In the case where the liquid developer is placed under a high electric field, for example, in a development step and a transfer step, the compound represented by formula (1) is easily separated from the amine-based dispersant toward a positive electrode. As the amine-based dispersant is separated toward the positive electrode side, the toner particles are easily electrophoresed toward a negative electrode along with the amine-based dispersant.

Examples of the amine-based dispersant include polymer dispersants having functional groups, such as aromatic amino groups, aliphatic amino groups, and nitrogen-containing heterocyclic groups. Among these, the reaction product of a polyamine compound and the self-condensation product of a hydroxycarboxylic acid can be used.

Examples of the polyamine compound include aliphatic polyamines, such as ethylenediamine, alicyclic polyamines, such as cyclopentanediamine, aromatic polyamines, such as phenylenediamine, araliphatic polyamines, such as xylylenediamine, and hydrazine and derivatives thereof. Among these, a polyamine compound having a polyethyleneimine framework or a polyallylamine framework, which has a high ability to adsorb the toner particles (adsorption ability), can be used.

Examples of the hydroxycarboxylic acid used in the self-condensation product of the hydroxycarboxylic acid include glycolic acid, lactic acid, oxybutyric acid, hydroxyvaleric acid, hydroxycaproic acid, hydroxycaprylic acid, hydroxycapric acid, hydroxylauric acid, hydoxymyristic acid, hydroxypalmitic acid, hydroxystearic acid, ricinoleic acid, castor oil fatty acid, and hydrogenated products thereof. Among these, a hydroxycarboxylic acid having 12 to 20 carbon atoms is preferably used, more preferably a 12-hydroxycarboxylic acid having 12 to 20 carbon atoms, even more preferably a 12-hydroxystearic acid.

Examples of a commercially available toner-particle dispersant (amine-based dispersant) include Ajisper PB817 (available from Ajinomoto Co., Inc.) and Solsperse 11200, 13940, 17000, and 18000 (available from Lubrizol Japan Limited).

The toner-particle dispersant (amine-based dispersant) can have an amine value of 2 to 150 mgKOH/g. In the case of the toner-particle dispersant (amine-based dispersant) having an amine value of 2 to 150 mgKOH/g, the dispersant has an enhanced ability to adsorb on the toner particles and thus can function as a toner-particle dispersant. Additionally, the electrical resistance of the liquid developer is easily maintained at a high level, and the liquid developer has better electrophoretic properties.

A method for measuring the amine value of the toner-particle dispersant (amine-based dispersant) will be described below.

As the liquid carrier, a liquid having a relatively low viscosity and high electrical insulation can be used. The liquid carrier preferably has a viscosity of 0.5 to 100 mPa·s, more preferably 0.5 to 20 mPa·s at 25° C.

Examples of the liquid carrier include simple liquid aliphatic hydrocarbons (simple liquid paraffin), such as dimethylbutane, dimethylpentane, dimethylpentane, octane, isooctane, decane, isodecane, decalin, nonane, dodecane, isododecane, Shellsol A100, Shellsol A150 (available from Shell Chemicals Japan Ltd.), and Moresco White P-60 (available from Moresco Corp.), liquid isoparaffins, such as Isopar E, Isopar G, Isopar H, Isopar L, Isopar M, and Isopar V (available from Exxon Mobil Corporation), and liquid polysiloxanes, such as silicone oil.

Among these, a liquid isoparaffin that is relatively inexpensive, has high electrical insulation, and is liquid at room temperature can be used.

The compound represented by formula (1) can have an affinity for the liquid carrier. Thus, each of R¹ and R² in formula (1) needs to be independently an alkyl group having 6 to 20 carbon atoms.

In the case where the number of carbons is less than 6, the compound has a decreased affinity for the liquid carrier, is not easily separated from surfaces of the toner particles and the toner-particle dispersant even under a high electric field, and is less likely to function as a charge-controlling agent.

In the case where the number of carbons is more than 20, the compound does not easily adsorb on the surfaces of the toner particles or the toner-particle dispersant even under a weak or no electric field and is less likely to function as a charge-controlling agent.

Studies by the inventors have revealed that in the case where R¹ and R² in formula (1) are each an alkyl group having 8 carbon atoms, the liquid developer can have the best balance between the high electrical resistance and excellent electrophoretic properties.

The compound represented by formula (1) can be contained in the liquid developer in an amount of 0.01 to 10 parts by mass based on 100 parts by mass of the toner particles.

In the case where the compound represented by formula (1) is contained in the liquid developer in an amount of 0.01 to 10 parts by mass based on 100 parts by mass of the toner particles, the toner particles can be subjected to electrophoresis, and the electrical resistance of the liquid developer is maintained at a high level.

The compound represented by formula (1) is contained in the liquid developer in an amount of 1 to 2,000 parts by mass based on 100 parts by mass of the toner-particle dispersant.

Examples of the binder resin of the toner particles contained in the liquid developer include epoxy resins, ester resins, (meth)acrylic resins, styrene-(meth)acrylic resins, alkyd resins, polyethylene resins, ethylene-(meth)acrylic resins, and rosin-modified resins. These may be used in combination of two or more.

Examples of the colorant in the toner particles contained in the liquid developer include organic pigments, organic dyes, inorganic pigments, dispersions containing pigments dispersed in, for example, insoluble resins serving as dispersion media, and pigments having surfaces on which resins are grafted.

Examples of pigments will be described below.

Examples of a pigment that exhibits yellow include C.I. Pigment Yellow 1, C.I. Pigment Yellow 2, C.I. Pigment Yellow 3, C.I. Pigment Yellow 4, C.I. Pigment Yellow 5, C.I. Pigment Yellow 6, C.I. Pigment Yellow 7, C.I. Pigment Yellow 10, C.I. Pigment Yellow 11, C.I. Pigment Yellow 12, C.I. Pigment Yellow 13, C.I. Pigment Yellow 14, C.I. Pigment Yellow 15, C.I. Pigment Yellow 16, C.I. Pigment Yellow 17, C.I. Pigment Yellow 23, C.I. Pigment Yellow 62, C.I. Pigment Yellow 65, C.I. Pigment Yellow 73, C.I. Pigment Yellow 74, C.I. Pigment Yellow 83, C.I. Pigment Yellow 93, C.I. Pigment Yellow 94, C.I. Pigment Yellow 95, C.I. Pigment Yellow 97, C.I. Pigment Yellow 109, C.I. Pigment Yellow 110, C.I. Pigment Yellow 111, C.I. Pigment Yellow 120, C.I. Pigment Yellow 127, C.I. Pigment Yellow 128, C.I. Pigment Yellow 129, C.I. Pigment Yellow 147, C.I. Pigment Yellow 151, C.I. Pigment Yellow 154, C.I. Pigment Yellow 155, C.I. Pigment Yellow 168, C.I. Pigment Yellow 174, C.I. Pigment Yellow 175, C.I. Pigment Yellow 176, C.I. Pigment Yellow 180, C.I. Pigment Yellow 181, and C.I. Pigment Yellow 185; and C.I. Vat Yellow 1, C.I. Vat Yellow 3, and C.I. Vat Yellow 20.

Examples of a pigment that exhibits red or magenta include C.I. Pigment Red 1, C.I. Pigment Red 2, C.I. Pigment Red 3, C.I. Pigment Red 4, C.I. Pigment Red 5, C.I. Pigment Red 6, C.I. Pigment Red 7, C.I. Pigment Red 8, C.I. Pigment Red 9, C.I. Pigment Red 10, C.I. Pigment Red 11, C.I. Pigment Red 12, C.I. Pigment Red 13, C.I. Pigment Red 14, C.I. Pigment Red 15, C.I. Pigment Red 16, C.I. Pigment Red 17, C.I. Pigment Red 18, C.I. Pigment Red 19, C.I. Pigment Red 21, C.I. Pigment Red 22, C.I. Pigment Red 23, C.I. Pigment Red 30, C.I. Pigment Red 31, C.I. Pigment Red 32, C.I. Pigment Red 37, C.I. Pigment Red 38, C.I. Pigment Red 39, C.I. Pigment Red 40, C.I. Pigment Red 41, C.I. Pigment Red 48:2, C.I. Pigment Red 48:3, C.I. Pigment Red 48:4, C.I. Pigment Red 49, C.I. Pigment Red 50, C.I. Pigment Red 51, C.I. Pigment Red 52, C.I. Pigment Red 53, C.I. Pigment Red 54, C.I. Pigment Red 55, C.I. Pigment Red 57:1, C.I. Pigment Red 58, C.I. Pigment Red 60, C.I. Pigment Red 63, C.I. Pigment Red 64, C.I. Pigment Red 68, C.I. Pigment Red 81:1, C.I. Pigment Red 83, C.I. Pigment Red 87, C.I. Pigment Red 88, C.I. Pigment Red 89, C.I. Pigment Red 90, C.I. Pigment Red 112, C.I. Pigment Red 114, C.I. Pigment Red 122, C.I. Pigment Red 123, C.I. Pigment Red 146, C.I. Pigment Red 147, C.I. Pigment Red 150, C.I. Pigment Red 163, C.I. Pigment Red 184, C.I. Pigment Red 202, C.I. Pigment Red 206, C.I. Pigment Red 207, C.I. Pigment Red 209, C.I. Pigment Red 238, and C.I. Pigment Red 269; C.I. Pigment Violet 19; and C.I. Vat Red 1, C.I. Vat Red 2, C.I. Vat Red 10, C.I. Vat Red 13, C.I. Vat Red 15, C.I. Vat Red 23, C.I. Vat Red 29, and C.I. Vat Red 35.

Examples of a pigment that exhibits blue or cyan include C.I. Pigment Blue 2, C.I. Pigment Blue 3, C.I. Pigment Blue 15:2, C.I. Pigment Blue 15:3, C.I. Pigment Blue 15:4, C.I. Pigment Blue 16, and C.I. Pigment Blue 17; C.I. Vat Blue 6; C.I. Acid Blue 45; and copper phthalocyanine pigments in which phthalocyanine frameworks are each substituted with 1 to 5 phthalimidomethyl groups.

Examples of a pigment that exhibits green include C.I. Pigment Green 7, C.I. Pigment Green 8, and C.I. Pigment Green 36.

Examples of a pigment that exhibits orange include C.I. Pigment Orange 66 and C.I. Pigment Orange 51.

Examples of a pigment that exhibits black include carbon black, titanium black, and aniline black.

Examples of a pigment that exhibits white include basic lead carbonate, zinc oxide, titanium oxide, and strontium titanate.

Examples of a dispersing device that can be used for dispersing a pigment in the toner particles include ball mills, sand mills, attritors, roll mills, jet mills, homogenizers, paint shakers, kneaders, agitators, Henschel mixers, colloid mills, ultrasonic homogenizers, pearl mills, wet-type jet mills.

A pigment dispersant may be added when the pigment is dispersed.

Examples of the pigment dispersant include hydroxy group-containing carboxylates, salts of long-chain polyaminoamide and high-molecular-weight acid esters, salts of high-molecular-weight poly(carboxylic acid), high-molecular-weight unsaturated acid esters, macromolecular copolymers, modified polyacrylates, aliphatic polycarboxylic acids, naphthalene sulfonate formaldehyde condensates, polyoxyethylene alkylphosphates, and pigment derivatives. Commercially available polymer dispersants, such as Lubrizol Solsperse series, can also be used.

Additionally, synergists in accordance with various pigments can be used as pigment dispersing aids.

The pigment dispersant and the pigment dispersing aid can be contained in the toner particles in an amount of 1 to 50 parts by mass based on 100 parts by mass of the pigment.

The liquid developer according to an embodiment of the present disclosure may contain, for example, additives for improving compatibility with recording media, storage stability, image storage stability, and other characteristics. Examples thereof include fillers, antifoaming agents, ultraviolet absorbers, antioxidants, anti-fading agents, fungicides, and anticorrosive agents.

Examples of a method for producing the liquid developer according to an embodiment of the present disclosure include a coacervation method and a wet pulverization method.

In the coacervation method, a colorant, a binder resin, a solvent that dissolves the binder resin, and a solvent that does not dissolve the binder resin are mixed together to prepare a liquid mixture. Removal of the solvent that dissolves the resin from the liquid mixture precipitates the binder resin that has been in a dissolved state to produce a liquid developer in which toner particles embedding a pigment are dispersed in the solvent that does not dissolve the binder resin.

Details of the coacervation method are described in, for example, Japanese Patent Laid-Open No. 2003-241439, International Publication Nos. 2007/000974 and 2007/000975.

Details of the wet pulverization method are described in, for example, International Publication Nos. 2006/126566 and 2007/108485.

In the wet pulverization method, a pigment and a binder resin are kneaded at a temperature equal to or higher than the melting point of the binder resin. The mixture is dry-ground into a ground product. The ground product is wet-pulverized in a liquid carrier to produce a liquid developer.

Methods for measuring physical properties related to an embodiment of the present disclosure will be described below.

### Method for Measuring Amine Value of Dispersant

The amine value of the dispersant was determined by a method described below.

The basic operation was based on ASTM D2074.

(1) First, 0.5 to 2.0 g of a specimen was accurately weighed. The mass at this time was denoted as M (g).
(2) The specimen was placed into a 50-mL beaker, and 25 mL of a tetrahydrofuran-ethanol (3/1) mixture was added thereto to dissolve the specimen.
(3) Measurement was performed with a potentiometric titrator using a 0.1 mol/L HCl ethanol solution (HCl solution). In the present disclosure, an automatic titrator (trade name: COM-2500, available from Hiranuma Sangyo Co., Ltd.) was used as the potentiometric titrator.
(4) The amount of HCl solution used at this time was denoted as S (mL). The blank was also measured, and the amount of HCl solution used at this time was denoted as B (mL).
(5) The acid value was calculated using the following formula, and f is the factor of the HCl solution.

Amine value [mgKOH/g]=(S−B)×f×5.61/M

### Method for Measuring Volume-Average Particle Diameter of Toner Particle

The volume-average particle diameter of the toner particles was measured with a laser diffraction/scattering particle size distribution analyzer (trade name: LA-950, available from Horiba, Ltd).

### Evaluation of Resistance of Liquid Developer

The resistance of the liquid developer was measured by a method described below.

The measurement was performed with a dielectric measurement system (trade name: 125596WB, available from Solartron) by the following method.

A measurement cell (trade name: SC-C1R-C, available from Toyo Corporation) into which 1.2 mL of a specimen was charged was connected to the measurement system and was adjusted to 25° C. The measurement was performed at an applied voltage of 3 V (root mean square value) while the frequency was changed in the range of 1 MHz to 0.1 Hz. The resulting complex impedance was presented using a Nyquist plot, and the resistance component and the capacitor component of the specimen were calculated by fitting with an RC parallel equivalent circuit. The volume resistivity was determined from the cell constant of the measurement cell.

### Measurement of Electrophoretic Mobility of Toner Particle (Toner)

The electrophoretic mobility of the toner particles was measured by the following method. A diluted specimen having a toner particle concentration of 1% by mass was held by a capillary force between parallel plate electrodes that were spaced 100 μm apart and that were each formed of a metal electrode having a thickness of 300 μm and a width of 20 mm.

The state of electrophoresis when a potential difference of 100 V was applied between the parallel plate electrodes (electric field intensity: 1×10⁶ V/m) was captured with a high-speed camera (trade name: FASTCAMSA-1, available from Photron Limited) connected to an optical microscope.

The resulting image was processed using image processing software (trade name: Image J, available from Wayne Rasband (NIH)), and the electrophoretic mobility of the toner particles (average value) was calculated by a particle image velocimetry (PIV) method.

### Evaluation of Dot Reproducibility

Dot reproducibility on a photosensitive drum was evaluated as described below.

First, 100 g of a liquid developer was charged into a developer tank 16 as a solution having a uniform concentration. The liquid developer is applied to a supply roller 15 adjusted so as to have a predetermined potential and conveyed to a developing roller 13. The liquid developer moved to the developing roller 13 is adjusted so as to have a desired developer concentration (25% to 35% by weight) with a squeegee roller 14, and then conveyed to a development nip between the developing roller 13 and a photosensitive drum 10.

An amorphous silicon drum was used as the photosensitive drum 10 and charged by a charging unit 11 arranged upstream of the development nip in such a manner that the surface was charged to 600 V. After charging, an electrostatic latent image having a one-dot-one-space pattern at 1,200 dpi was formed by an exposure unit 12 in such a manner that an image area had a potential of 200 V. The photosensitive drum had a circumferential velocity of 700 mm/s.

A bias of 400 V is applied to the developing roller 13. The negatively charged liquid developer is selectively moved to the image area. The liquid carrier is separated into both the developing roller 13 and the photosensitive drum 10 at a development nip portion.

The evaluation apparatus was stopped before the liquid developer moved from the developing roller 13 onto the photosensitive drum 10 reached the position of a cleaning member 17. Then the photosensitive drum 10 was immediately removed from the apparatus. An image on the photosensitive drum was observed with a digital microscope (trade name: VHX-5000, available from Keyence Corporation).

FIGURE illustrates an example of an image-forming apparatus (electrophotographic apparatus) including a liquid developer.

In the image-forming apparatus illustrated in FIGURE, the surface of the photosensitive drum (electrophotographic photosensitive member) 10 is charged by the charging unit 11. The surface of the photosensitive drum 10 is irradiated with image exposure light from the exposure unit 12 to form an electrostatic latent image. The liquid developer accommodated in the liquid developer tank 16 is supplied to the developing roller 13 via the supply roller 15. The liquid developer supplied to the developing roller 13 passes between the developing roller 13 and the squeegee roller 14 and develops the electrostatic latent image formed on the surface of the photosensitive drum 10 to form a toner image.

The toner image is transferred from the photosensitive drum 10 to a recording medium by a transfer unit (not illustrated) with or without an intermediate transfer member (not illustrated). The toner image transferred to the recording medium is fixed on the recording medium by a fixing unit (not illustrated). The liquid developer remaining on the surface of the photosensitive drum 10 without being transferred is removed by the cleaning member 17 to clean the surface of the photosensitive drum 10.

According to an embodiment of the present disclosure, the liquid developer having a high electrical resistance (volume resistivity) and containing toner particles having excellent electrophoretic properties can be provided.

### EXAMPLES

While the present disclosure will be specifically described below by examples, the present disclosure is not limited to configurations realized in the examples. The term “parts” indicates “parts by mass” unless otherwise specified.

### Example 1

### Production Example of Polymer A1

Solvent: toluene: 100.0 parts
Behenyl acrylate: 80.5 parts
tert-Butyl peroxypivalate (trade name: Perbutyl PV, available from NOF Corporation) serving as polymerization initiator: 0.5 parts

The above-described materials were charged into a reaction vessel equipped with a reflux condenser, a stirrer, a thermometer, and a nitrogen inlet in a nitrogen atmosphere. A polymerization reaction was performed by heating the mixture to 70° C. under stirring at 200 rpm in the reaction vessel for 12 hours, thereby providing a solution containing a polymer of a monomeric composition dissolved in toluene. Subsequently, the solution was cooled to 25° C. and then poured into 1000.0 parts of methanol under stirring to precipitate a methanol-insoluble substance. The resulting methanol-insoluble substance was removed by filtration, washed with methanol, and vacuum-dried at 40° C. for 24 hours to obtain polymer A1. Polymer A1 had a weight-average molecular weight of 58,500 and a melting point of 57.2° C.

### Production of Liquid Developer 1

Polymer A1: 83.0 parts
Pigment (Pigment Blue 15:3): 17.0 parts

The above-described materials were mixed together using a Henschel mixer. The mixture was melt-kneaded with a co-rotating twin-screw extruder having a heating temperature in the roll of 100° C. The resulting mixture was cooled and coarsely ground to obtain coarsely ground toner particles.

Next, 80.0 parts of a liquid isoparaffin (trade name: Isopar L, available from Exxon Mobil Corporation), 20.0 parts of the coarsely ground toner particles, and 0.6 parts of a polymer dispersant (amine value: 25 mgKOH/g) prepared by the graft polymerization of a 12-hydroxystearic acid condensate (average degree of condensation: 2.5) onto a dispersant (weight-average molecular weight: 8,000) having a polyallylamine framework were mixed together using a sand mill for 72 hours to prepare toner particle dispersion 1.

Then 0.02 parts of the compound represented by formula (1), where R¹ and R² are each a linear alkyl group having 8 carbon atoms, was added thereto to prepare liquid developer 1.

The toner particles in liquid developer 1 had a volume-average particle diameter of 0.70 μm.

The volume resistivity of liquid developer 1 was evaluated by the above-described method. The measurement results of the volume resistivity of the liquid developer were rated in accordance with the following criteria.

Rank A: 5.0×10¹² Ω·cm or more
Rank B: 1.0×10¹² Ω·cm or more and less than 5.0×10¹² Ω·cm
Rank C: 5.0×10¹¹ Ω·cm or more and less than 1.0×10¹² Ω·cm
Rank D: 1.0×10¹¹ Ω·cm or more and less than 5.0×10¹¹ Ω·cm
Rank E: less than 1.0×10¹¹ Ω·cm

The volume resistivity of liquid developer 1 was 9.0×10¹² Ω·cm and rated Rank A in accordance with the evaluation criteria.

The electrophoretic mobility of the toner in liquid developer 1 was evaluated by the method described above. The measurement results of the electrophoretic mobility of the toner in the liquid developer were rated in accordance with the following criteria.

Rank A: 1.0×10⁻⁹ m²/V·s or more
Rank B: 7.0×10⁻¹⁰ m²/V·s or more and less than 1.0×10⁻⁹ m²/V·s
Rank C: 3.0×10⁻¹⁰ m²/V·s or more and less than 7.0×10⁻¹° m²/V·s
Rank D: 1.0×10⁻¹⁰ m²/V·s or more and less than 3.0×10⁻¹° m²/V·s
Rank E: less than 1.0×10⁻¹⁰ m²/V·s or no clear migration

The electrophoretic mobility of the toner in liquid developer 1 was 5.2×10⁻⁹ m²/V·s and rated Rank A in accordance with the evaluation criteria.

The dot reproducibility of liquid developer 1 was evaluated by the method described above. The measurement results of the dot reproducibility of the liquid developer were rated in accordance with the following criteria.

Rank A: The shape and area of the dots are uniform, and no background toner is observed.
Rank B: The shape of the dots is uniform, the area of the dots is slightly nonuniform, and no background toner is observed.
Rank C: The shape and area of the dots are nonuniform, and no background toner is observed.
Rank D: Scattering of the toner to the background is observed, and the dots can be recognized.
Rank E: No dots can be recognized.

In this example, in the case of using liquid developer 1, the dots on the photosensitive drum were highly uniform in shape and area, and no background toner was observed. The dot reproducibility was rated Rank A in accordance with the evaluation criteria.

### Example 2

### Production of Liquid Developer 2

Polymer A1: 83.0 parts
Pigment (Pigment Blue 15:3): 17.0 parts

The above-described materials were mixed together using a Henschel mixer. The mixture was melt-kneaded with a co-rotating twin-screw extruder having a heating temperature in the roll of 100° C. The resulting mixture was cooled and coarsely ground to obtain coarsely ground toner particles.

Next, 80.0 parts of a liquid isoparaffin (trade name: Isopar L, available from Exxon Mobil Corporation), 20.0 parts of the coarsely ground toner particles, and 1.6 parts of a polymer dispersant (amine value: 105 mgKOH/g) prepared by the graft polymerization of a 12-hydroxystearic acid condensate (average degree of condensation: 3.8) onto a dispersant (weight-average molecular weight: 6,000) having a polyethyleneimine framework were mixed together using a sand mill for 72 hours to prepare toner particle dispersion 2.

Then 0.06 parts of the compound represented by formula (1), where R¹ and R² are each a linear alkyl group having 12 carbon atoms, was added thereto to prepare liquid developer 2.

The toner particles in liquid developer 2 had a volume-average particle diameter of 0.73 μm.

The volume resistivity of liquid developer 2 was 6.5×10¹² Ω·cm, which was slightly lower than that of Example 1, and was rated Rank A.

The electrophoretic mobility of the toner in liquid developer 2 was 5.0×10⁻⁹ m²/V·s and rated Rank A.

The dot reproducibility of liquid developer 2 was rated Rank A.

### Example 3

### Production of Liquid Developer 3

Polymer A1: 83.0 parts
Pigment (Pigment Blue 15:3): 17.0 parts

The above-described materials were mixed together using a Henschel mixer. The mixture was melt-kneaded with a co-rotating twin-screw extruder having a heating temperature in the roll of 100° C. The resulting mixture was cooled and coarsely ground to obtain coarsely ground toner particles.

Next, 80.0 parts of a simple liquid paraffin (trade name: Moresco White P-60, available from Moresco Corp.), 20.0 parts of the coarsely ground toner particles, and 1.6 parts of a polymer dispersant (amine value: 105 mgKOH/g) prepared by the graft polymerization of a 12-hydroxystearic acid condensate (average degree of condensation: 3.8) onto a dispersant (weight-average molecular weight: 6,000) having a polyethyleneimine framework were mixed together using a sand mill for 72 hours to prepare toner particle dispersion 3.

Then 0.06 parts of the compound represented by formula (1), where R¹ and R² are each a linear alkyl group having 12 carbon atoms, was added thereto to prepare liquid developer 3.

The toner particles in liquid developer 3 had a volume-average particle diameter of 0.72 μm.

The volume resistivity of liquid developer 3 was 6.3×10¹² Ω·cm, which was slightly lower than that of Example 1, and was rated Rank A.

The electrophoretic mobility of the toner in liquid developer 3 was 2.8×10⁻⁹ m²/V·s and rated Rank A.

The dot reproducibility of liquid developer 3 was slightly inferior to those of Examples 1 and 2 and rated Rank A.

### Example 4

### Production of Liquid Developer 4

Polymer A1: 83.0 parts
Pigment (Pigment Blue 15:3): 17.0 parts

The above-described materials were mixed together using a Henschel mixer. The mixture was melt-kneaded with a co-rotating twin-screw extruder having a heating temperature in the roll of 100° C. The resulting mixture was cooled and coarsely ground to obtain coarsely ground toner particles.

Next, 80.0 parts of a silicone oil (trade name: KF-96L-2CS, available from Shin-Etsu Chemical Co., Ltd.), 20.0 parts of the coarsely ground toner particles, and 0.6 parts of a polymer dispersant (amine value: 25 mgKOH/g) prepared by the graft polymerization of a 12-hydroxystearic acid condensate (average degree of condensation: 2.5) onto a dispersant (weight-average molecular weight: 8,000) having a polyallylamine framework were mixed together using a sand mill for 72 hours to prepare toner particle dispersion 4.

Then 0.02 parts of the compound represented by formula (1), where R¹ and R² are each a linear alkyl group having 12 carbon atoms, was added thereto to prepare liquid developer 4.

The toner particles in liquid developer 4 had a volume-average particle diameter of 0.71 μm.

The volume resistivity of liquid developer 4 was 8.6×10¹² Ω·cm, which was slightly lower than that of Example 1, and was rated Rank A.

The electrophoretic mobility of the toner in liquid developer 4 was 9.0×10⁻¹⁰ m²/V·s and rated Rank B.

The dot reproducibility of liquid developer 4 was slightly inferior to those of Examples 1 and 2 and rated Rank A.

### Example 5

### Production of Liquid Developer 5

Polymer A1: 83.0 parts
Pigment (Pigment Blue 15:3): 17.0 parts

The above-described materials were mixed together using a Henschel mixer. The mixture was melt-kneaded with a co-rotating twin-screw extruder having a heating temperature in the roll of 100° C. The resulting mixture was cooled and coarsely ground to obtain coarsely ground toner particles.

Next, 80.0 parts of a liquid isoparaffin (trade name: Isopar L, available from Exxon Mobil Corporation), 20.0 parts of the coarsely ground toner particles, and 0.1 parts of a polymer dispersant (amine value: 25 mgKOH/g) prepared by the graft polymerization of a 12-hydroxystearic acid condensate (average degree of condensation: 2.5) onto a dispersant (weight-average molecular weight: 8,000) having a polyallylamine framework were mixed together using a sand mill for 72 hours to prepare toner particle dispersion 5.

Then 1.8 parts of the compound represented by formula (1), where R¹ and R² are each a linear alkyl group having 8 carbon atoms, was added thereto to prepare liquid developer 5.

The toner particles in liquid developer 5 had a volume-average particle diameter of 0.74 μm.

The volume resistivity of liquid developer 5 was 5.9×10¹² Ω·cm and rated Rank A. The electrophoretic mobility of the toner in liquid developer 5 was 5.2×10⁻⁹ m²/V·s and rated Rank A.

The dot reproducibility of liquid developer 5 was slightly inferior to those of Examples 1 and 2 and rated Rank A.

### Example 6

### Production of Liquid Developer 6

Polymer A1: 83.0 parts
Pigment (Pigment Blue 15:3): 17.0 parts

The above-described materials were mixed together using a Henschel mixer. The mixture was melt-kneaded with a co-rotating twin-screw extruder having a heating temperature in the roll of 100° C. The resulting mixture was cooled and coarsely ground to obtain coarsely ground toner particles.

Next, 80.0 parts of a simple liquid paraffin (trade name: Moresco White P-60, available from Moresco Corp.), 20.0 parts of the coarsely ground toner particles, and 1.2 parts of a polymer dispersant (amine value: 105 mgKOH/g) prepared by the graft polymerization of a 12-hydroxystearic acid condensate (average degree of condensation: 3.8) onto a dispersant (weight-average molecular weight: 6,000) having a polyethyleneimine framework were mixed together using a sand mill for 72 hours to prepare toner particle dispersion 6.

Then 0.01 parts of the compound represented by formula (1), where R¹ and R² are each a linear alkyl group having 12 carbon atoms, was added thereto to prepare liquid developer 6.

The toner particles in liquid developer 6 had a volume-average particle diameter of 0.74 μm.

The volume resistivity of liquid developer 6 was 5.8×10¹² Ω·cm, which was slightly lower than that of Example 1, and was rated Rank A.

The electrophoretic mobility of the toner in liquid developer 6 was 8.8×10⁻¹⁰ m²/V·s and rated Rank B.

The dot reproducibility of liquid developer 6 was slightly inferior to those of Examples 1 to 5 and lacked in uniformity. However, no background toner was observed. The dot reproducibility was rated Rank B.

### Example 7

### Production of Liquid Developer 7

Polymer A1: 83.0 parts
Pigment (Pigment Blue 15:3): 17.0 parts

The above-described materials were mixed together using a Henschel mixer. The mixture was melt-kneaded with a co-rotating twin-screw extruder having a heating temperature in the roll of 100° C. The resulting mixture was cooled and coarsely ground to obtain coarsely ground toner particles.

Next, 80.0 parts of a simple liquid paraffin (trade name: Moresco White P-60, available from Moresco Corp.), 20.0 parts of the coarsely ground toner particles, and 0.08 parts of a polymer dispersant (amine value: 105 mgKOH/g) prepared by the graft polymerization of a 12-hydroxystearic acid condensate (average degree of condensation: 3.8) onto a dispersant (weight-average molecular weight: 6,000) having a polyethyleneimine framework were mixed together using a sand mill for 72 hours to prepare toner particle dispersion 7.

Then 1.8 parts of the compound represented by formula (1), where R¹ and R² are each a linear alkyl group having 12 carbon atoms, was added thereto to prepare liquid developer 7. The toner particles in liquid developer 7 had a volume-average particle diameter of 0.73 μm. The volume resistivity of liquid developer 7 was 6.2×10¹² Ω·cm and rated Rank A.

The electrophoretic mobility of the toner in liquid developer 7 was 2.8×10⁻⁹ m²/V·s, which was slightly lower than those of Examples 1, 2, and 5, and was rated Rank A.

The dot reproducibility of liquid developer 7 was slightly inferior to those of Examples 1 to 5 and lacked in uniformity. However, no background toner was observed. The dot reproducibility was rated Rank B.

### Example 8

### Production of Liquid Developer 8

Polymer A1: 83.0 parts
Pigment (Pigment Blue 15:3): 17.0 parts

The above-described materials were mixed together using a Henschel mixer. The mixture was melt-kneaded with a co-rotating twin-screw extruder having a heating temperature in the roll of 100° C. The resulting mixture was cooled and coarsely ground to obtain coarsely ground toner particles.

Next, 80.0 parts of a simple liquid paraffin (trade name: Moresco White P-60, available from Moresco Corp.), 20.0 parts of the coarsely ground toner particles, and 0.004 parts of a polymer dispersant (amine value: 105 mgKOH/g) prepared by the graft polymerization of a 12-hydroxystearic acid condensate (average degree of condensation: 3.8) onto a dispersant (weight-average molecular weight: 6,000) having a polyethyleneimine framework were mixed together using a sand mill for 72 hours to prepare toner particle dispersion 8.

Then 0.08 parts of the compound represented by formula (1), where IV and R² are each a linear alkyl group having 12 carbon atoms, was added thereto to prepare liquid developer 8. The toner particles in liquid developer 8 had a volume-average particle diameter of 0.75 μm. The volume resistivity of liquid developer 8 was 7.1×10¹² Ω·cm and rated Rank A.

The electrophoretic mobility of the toner in liquid developer 8 was 6.8×10⁻¹⁰ m²/V·s and rated Rank C.

The dot reproducibility of liquid developer 8 was slightly inferior to those of Examples 1 to 5 and lacked in uniformity. However, no background toner was observed. The dot reproducibility was rated Rank B.

### Example 9

### Production of Liquid Developer 9

Polymer A1: 83.0 parts
Pigment (Pigment Blue 15:3): 17.0 parts

The above-described materials were mixed together using a Henschel mixer. The mixture was melt-kneaded with a co-rotating twin-screw extruder having a heating temperature in the roll of 100° C. The resulting mixture was cooled and coarsely ground to obtain coarsely ground toner particles.

Next, 80.0 parts of a simple liquid paraffin (trade name: Moresco White P-60, available from Moresco Corp.), 20.0 parts of the coarsely ground toner particles, and 0.001 parts of a polymer dispersant (amine value: 105 mgKOH/g) prepared by the graft polymerization of a 12-hydroxystearic acid condensate (average degree of condensation: 3.8) onto a dispersant (weight-average molecular weight: 6,000) having a polyethyleneimine framework were mixed together using a sand mill for 72 hours to prepare toner particle dispersion 9.

Then 0.02 parts of the compound represented by formula (1), where IV and R² are each a linear alkyl group having 12 carbon atoms, was added thereto to prepare liquid developer 9. The toner particles in liquid developer 9 had a volume-average particle diameter of 0.75 μm. The volume resistivity of liquid developer 9 was 8.1×10¹² Ω·cm and rated Rank A.

The electrophoretic mobility of the toner in liquid developer 9 was 6.5×10⁻¹⁰ m²/V·s and rated Rank C.

The dot reproducibility of liquid developer 9 was lacked in uniformity as compared with Examples 1 to 8. However, no background toner was observed. The dot reproducibility was rated Rank C.

### Example 10

### Production of Liquid Developer 10

Polymer A1: 83.0 parts
Pigment (Pigment Blue 15:3): 17.0 parts

The above-described materials were mixed together using a Henschel mixer. The mixture was melt-kneaded with a co-rotating twin-screw extruder having a heating temperature in the roll of 100° C. The resulting mixture was cooled and coarsely ground to obtain coarsely ground toner particles.

Next, 80.0 parts of a simple liquid paraffin (trade name: Moresco White P-60, available from Moresco Corp.), 20.0 parts of the coarsely ground toner particles, and 2.4 parts of a polymer dispersant (amine value: 105 mgKOH/g) prepared by the graft polymerization of a 12-hydroxystearic acid condensate (average degree of condensation: 3.8) onto a dispersant (weight-average molecular weight: 6,000) having a polyethyleneimine framework were mixed together using a sand mill for 72 hours to prepare toner particle dispersion 10.

Then 0.02 parts of the compound represented by formula (1), where IV and R² are each a linear alkyl group having 12 carbon atoms, was added thereto to prepare liquid developer 10. The toner particles in liquid developer 10 had a volume-average particle diameter of 0.71 μm. The volume resistivity of liquid developer 10 was 3.0×10¹² Ω·cm and rated Rank B.

The electrophoretic mobility of the toner in liquid developer 10 was 5.9×10⁻¹⁰ m²/V·s and rated Rank C.

The dot reproducibility of liquid developer 10 was lacked in uniformity as compared with Examples 1 to 8. However, no background toner was observed. The dot reproducibility was rated Rank C.

### Example 11

### Production of Liquid Developer 11

Polymer A1: 83.0 parts
Pigment (Pigment Blue 15:3): 17.0 parts

The above-described materials were mixed together using a Henschel mixer. The mixture was melt-kneaded with a co-rotating twin-screw extruder having a heating temperature in the roll of 100° C. The resulting mixture was cooled and coarsely ground to obtain coarsely ground toner particles.

Next, 80.0 parts of a simple liquid paraffin (trade name: Moresco White P-60, available from Moresco Corp.), 20.0 parts of the coarsely ground toner particles, and 2.4 parts of a polymer dispersant (amine value: 2 mgKOH/g) prepared by the graft polymerization of a 12-hydroxystearic acid condensate (average degree of condensation: 4.8) onto a dispersant (weight-average molecular weight: 6,000) having a polyethyleneimine framework were mixed together using a sand mill for 72 hours to prepare toner particle dispersion 11.

Then 0.02 parts of the compound represented by formula (1), where IV and R² are each a linear alkyl group having 12 carbon atoms, was added thereto to prepare liquid developer 11. The toner particles in liquid developer 11 had a volume-average particle diameter of 0.75 μm. The volume resistivity of liquid developer 11 was 3.0×10¹² Ω·cm and rated Rank B.

The electrophoretic mobility of the toner in liquid developer 11 was 2.8×10⁻¹⁰ m²/V·s and rated Rank D. The dot reproducibility of liquid developer 11 was inferior to those of Examples 1 to 10. Although the scattering of the toner to the background was observed, the dots were recognizable. The dot reproducibility was rated Rank D.

### Example 12

### Production of Liquid Developer 12

Polymer A1: 83.0 parts
Pigment (Pigment Blue 15:3): 17.0 parts

The above-described materials were mixed together using a Henschel mixer. The mixture was melt-kneaded with a co-rotating twin-screw extruder having a heating temperature in the roll of 100° C. The resulting mixture was cooled and coarsely ground to obtain coarsely ground toner particles.

Next, 80.0 parts of a simple liquid paraffin (trade name: Moresco White P-60, available from Moresco Corp.), 20.0 parts of the coarsely ground toner particles, and 2.4 parts of a polymer dispersant (amine value: 145 mgKOH/g) prepared by the graft polymerization of a 12-hydroxystearic acid condensate (average degree of condensation: 3.0) onto a dispersant (weight-average molecular weight: 6,000) having a polyethyleneimine framework were mixed together using a sand mill for 72 hours to prepare toner particle dispersion 12.

Then 0.02 parts of the compound represented by formula (1), where IV and R² are each a linear alkyl group having 12 carbon atoms, was added thereto to prepare liquid developer 12. The toner particles in liquid developer 12 had a volume-average particle diameter of 0.74 μm. The volume resistivity of liquid developer 12 was 9.1×10¹¹ Ω·cm and rated Rank C.

The electrophoretic mobility of the toner in liquid developer 12 was 5.4×10⁻¹⁰ m²/V·s and rated Rank C. The dot reproducibility of liquid developer 12 was inferior to those of Examples 1 to 10. Although the scattering of the toner to the background was observed, the dots were recognizable. The dot reproducibility was rated Rank D.

### Example 13

### Production of Liquid Developer 13

Polymer A1: 83.0 parts
Pigment (Pigment Blue 15:3): 17.0 parts

The above-described materials were mixed together using a Henschel mixer. The mixture was melt-kneaded with a co-rotating twin-screw extruder having a heating temperature in the roll of 100° C. The resulting mixture was cooled and coarsely ground to obtain coarsely ground toner particles.

Next, 80.0 parts of a simple liquid paraffin (trade name: Moresco White P-60, available from Moresco Corp.), 20.0 parts of the coarsely ground toner particles, and 2.4 parts of a polymer dispersant (amine value: 160 mgKOH/g) prepared by the graft polymerization of a 12-hydroxystearic acid condensate (average degree of condensation: 3.9) onto a dispersant (weight-average molecular weight: 6,000) having a polyethyleneimine framework were mixed together using a sand mill for 72 hours to prepare toner particle dispersion 13.

Then 0.01 parts of the compound represented by formula (1), where R¹ and R² are each a linear alkyl group having 12 carbon atoms, was added thereto to prepare liquid developer 13. The toner particles in liquid developer 13 had a volume-average particle diameter of 0.74 μm. The volume resistivity of liquid developer 13 was 2.0×10¹¹ Ω·cm and rated Rank D.

The electrophoretic mobility of the toner in liquid developer 13 was 5.4×10⁻¹⁰ m²/V·s and rated Rank C. The dot reproducibility of liquid developer 13 was inferior to those of Examples 1 to 10. Although a large amount of the toner was scattered to the background, the dots were recognizable. The dot reproducibility was rated Rank D.

### Example 14

### Production of Liquid Developer 14

Polymer A1: 83.0 parts
Pigment (Pigment Blue 15:3): 17.0 parts

The above-described materials were mixed together using a Henschel mixer. The mixture was melt-kneaded with a co-rotating twin-screw extruder having a heating temperature in the roll of 100° C. The resulting mixture was cooled and coarsely ground to obtain coarsely ground toner particles.

Next, 80.0 parts of a simple liquid paraffin (trade name: Moresco White P-60, available from Moresco Corp.), 20.0 parts of the coarsely ground toner particles, and 2.4 parts of a polymer dispersant (amine value: 160 mgKOH/g) prepared by the graft polymerization of a 12-hydroxystearic acid condensate (average degree of condensation: 3.9) onto a dispersant (weight-average molecular weight: 6,000) having a polyethyleneimine framework were mixed together using a sand mill for 72 hours to prepare toner particle dispersion 14.

Then 0.004 parts of the compound represented by formula (1), where R¹ and R² are each a linear alkyl group having 12 carbon atoms, was added thereto to prepare liquid developer 14. The toner particles in liquid developer 14 had a volume-average particle diameter of 0.73 μm. The volume resistivity of liquid developer 14 was 4.0×10¹¹ Ω·cm and rated Rank D.

The electrophoretic mobility of the toner in liquid developer 14 was 1.5×10⁻¹⁰ m²/V·s and rated Rank D. The dot reproducibility of liquid developer 14 was inferior to those of Examples 1 to 10. Although a large amount of the toner was scattered to the background, the dots were recognizable. The dot reproducibility was rated Rank D.

### Example 15

### Production of Liquid Developer 15

Polymer A1: 83.0 parts
Pigment (Pigment Blue 15:3): 17.0 parts

The above-described materials were mixed together using a Henschel mixer. The mixture was melt-kneaded with a co-rotating twin-screw extruder having a heating temperature in the roll of 100° C. The resulting mixture was cooled and coarsely ground to obtain coarsely ground toner particles.

Next, 80.0 parts of a simple liquid paraffin (trade name: Moresco White P-60, available from Moresco Corp.), 20.0 parts of the coarsely ground toner particles, and 2.4 parts of a polymer dispersant (amine value: 160 mgKOH/g) prepared by the graft polymerization of a 12-hydroxystearic acid condensate (average degree of condensation: 3.9) onto a dispersant (weight-average molecular weight: 6,000) having a polyethyleneimine framework were mixed together using a sand mill for 72 hours to prepare toner particle dispersion 15.

Then 0.001 parts of the compound represented by formula (1), where R¹ and R² are each a linear alkyl group having 12 carbon atoms, was added thereto to prepare liquid developer 15. The toner particles in liquid developer 15 had a volume-average particle diameter of 0.73 μm. The volume resistivity of liquid developer 15 was 8.6×10¹¹ Ω·cm and rated Rank C.

The electrophoretic mobility of the toner in liquid developer 15 was 1.1×10⁻¹⁰ m²/V·s and rated Rank D. The dot reproducibility of liquid developer 15 was inferior to those of Examples 1 to 10. Although a large amount of the toner was scattered to the background, the dots were recognizable. The dot reproducibility was rated Rank D.

### Example 16

### Production of Liquid Developer 16

Polymer A1: 83.0 parts
Pigment (Pigment Blue 15:3): 17.0 parts

The above-described materials were mixed together using a Henschel mixer. The mixture was melt-kneaded with a co-rotating twin-screw extruder having a heating temperature in the roll of 100° C. The resulting mixture was cooled and coarsely ground to obtain coarsely ground toner particles.

Next, 80.0 parts of a simple liquid paraffin (trade name: Moresco White P-60, available from Moresco Corp.), 20.0 parts of the coarsely ground toner particles, and 0.08 parts of a polymer dispersant (amine value: 160 mgKOH/g) prepared by the graft polymerization of a 12-hydroxystearic acid condensate (average degree of condensation: 3.9) onto a dispersant (weight-average molecular weight: 6,000) having a polyethyleneimine framework were mixed together using a sand mill for 72 hours to prepare toner particle dispersion 16.

Then 2.4 parts of the compound represented by formula (1), where R¹ and R² are each a linear alkyl group having 12 carbon atoms, was added thereto to prepare liquid developer 16. The toner particles in liquid developer 16 had a volume-average particle diameter of 0.71 μm. The volume resistivity of liquid developer 16 was 3.3×10¹¹ Ω·cm and rated Rank C.

The electrophoretic mobility of the toner in liquid developer 16 was 5.4×10⁻¹⁰ m²/V·s and rated Rank D. The dot reproducibility of liquid developer 16 was inferior to those of Examples 1 to 15. Although a large amount of the toner was scattered to the background, the dots were recognizable. The dot reproducibility was rated Rank D.

### Example 17

### Production of Liquid Developer 17

Polymer A1: 83.0 parts
Pigment (Pigment Blue 15:3): 17.0 parts

The above-described materials were mixed together using a Henschel mixer. The mixture was melt-kneaded with a co-rotating twin-screw extruder having a heating temperature in the roll of 100° C. The resulting mixture was cooled and coarsely ground to obtain coarsely ground toner particles.

Next, 80.0 parts of a simple liquid paraffin (trade name: Moresco White P-60, available from Moresco Corp.), 20.0 parts of the coarsely ground toner particles, and 0.08 parts of a polymer dispersant (amine value: 160 mgKOH/g) prepared by the graft polymerization of a 12-hydroxystearic acid condensate (average degree of condensation: 3.9) onto a dispersant (weight-average molecular weight: 6,000) having a polyethyleneimine framework were mixed together using a sand mill for 72 hours to prepare toner particle dispersion 17.

Then 2.4 parts of the compound represented by formula (1), where R¹ and R² are each a linear alkyl group having 6 carbon atoms, was added thereto to prepare liquid developer 17. The toner particles in liquid developer 17 had a volume-average particle diameter of 0.73 μm. The volume resistivity of liquid developer 17 was 2.9×10¹¹ Ω·cm and rated Rank D.

The electrophoretic mobility of the toner in liquid developer 17 was 2.8×10⁻¹⁰ m²/V·s and rated Rank D. The dot reproducibility of liquid developer 17 was inferior to those of Examples 1 to 15. Although a large amount of the toner was scattered to the background, the dots were recognizable. The dot reproducibility was rated Rank D.

### Example 18

### Production of Liquid Developer 18

Polymer A1: 83.0 parts
Pigment (Pigment Blue 15:3): 17.0 parts

The above-described materials were mixed together using a Henschel mixer. The mixture was melt-kneaded with a co-rotating twin-screw extruder having a heating temperature in the roll of 100° C. The resulting mixture was cooled and coarsely ground to obtain coarsely ground toner particles.

Next, 80.0 parts of a simple liquid paraffin (trade name: Moresco White P-60, available from Moresco Corp.), 20.0 parts of the coarsely ground toner particles, and 2.4 parts of a polymer dispersant (amine value: 160 mgKOH/g) prepared by the graft polymerization of a 12-hydroxystearic acid condensate (average degree of condensation: 3.9) onto a dispersant (weight-average molecular weight: 6,000) having a polyethyleneimine framework were mixed together using a sand mill for 72 hours to prepare toner particle dispersion 18.

Then 0.001 parts of the compound represented by formula (1), where R¹ and R² are each a linear alkyl group having 20 carbon atoms, was added thereto to prepare liquid developer 18. The toner particles in liquid developer 18 had a volume-average particle diameter of 0.74 μm. The volume resistivity of liquid developer 18 was 1.5×10¹¹ Ω·cm and rated Rank D.

The electrophoretic mobility of the toner in liquid developer 18 was 2.6×10⁻¹⁰ m²/V·s and rated Rank D. The dot reproducibility of liquid developer 18 was inferior to those of Examples 1 to 15. Although a large amount of the toner was scattered to the background, the dots were recognizable. The dot reproducibility was rated Rank D.

### Comparative Example 1

### Production of Liquid Developer 19

Polymer A1: 83.0 parts
Pigment (Pigment Blue 15:3): 17.0 parts

The above-described materials were mixed together using a Henschel mixer. The mixture was melt-kneaded with a co-rotating twin-screw extruder having a heating temperature in the roll of 100° C. The resulting mixture was cooled and coarsely ground to obtain coarsely ground toner particles.

Next, 80.0 parts of ethylene glycol diethyl ether (EGDEA), 20.0 parts of the coarsely ground toner particles, and 0.08 parts of a polymer dispersant (amine value: 160 mgKOH/g) prepared by the graft polymerization of a 12-hydroxystearic acid condensate (average degree of condensation: 3.9) onto a dispersant (weight-average molecular weight: 6,000) having a polyethyleneimine framework were mixed together using a sand mill for 72 hours to prepare toner particle dispersion 19.

Then 2.4 parts of the compound represented by formula (1), where IV and R² are each a linear alkyl group having 6 carbon atoms, was added thereto to prepare liquid developer 19. The toner particles in liquid developer 19 had a volume-average particle diameter of 0.73 μm. The volume resistivity of liquid developer 19 was 5.9×10¹⁰ Ω·cm and rated Rank E.

The electrophoretic mobility of the toner in liquid developer 19 was 2.5×10⁻¹⁰ m²/V·s and rated Rank D.

The dot reproducibility of liquid developer 19 was inferior to those of Examples 1 to 18. No dots were recognizable. The dot reproducibility was rated Rank E.

### Comparative Example 2

### Production of Liquid Developer 20

Polymer A1: 83.0 parts
Pigment (Pigment Blue 15:3): 17.0 parts

The above-described materials were mixed together using a Henschel mixer. The mixture was melt-kneaded with a co-rotating twin-screw extruder having a heating temperature in the roll of 100° C. The resulting mixture was cooled and coarsely ground to obtain coarsely ground toner particles.

Next, 80.0 parts of a simple liquid paraffin (trade name: Moresco White P-60, available from Moresco Corp.), 20.0 parts of the coarsely ground toner particles, and 0.08 parts of a dispersant having a polypyrrolidone framework (trade name: AntaronV-216, available from Ashland Japan Ltd, amine value: 0 mgKOH/g) were mixed together using a sand mill for 72 hours to prepare toner particle dispersion 20.

Then 2.4 parts of the compound represented by formula (1), where R¹ and R² are each a linear alkyl group having 6 carbon atoms, was added thereto to prepare liquid developer 20. The toner particles in liquid developer 20 had a volume-average particle diameter of 0.73 μm. The volume resistivity of liquid developer 20 was 2.8×10¹¹ Ω·cm and rated Rank D.

The electrophoretic mobility of the toner in liquid developer 20 was 7.5×10⁻¹¹ m²/V·s and rated Rank D.

The dot reproducibility of liquid developer 20 was inferior to those of Examples 1 to 18. No dots were recognizable. The dot reproducibility was rated Rank E.

### Comparative Example 3

### Production of Liquid Developer 21

Polymer A1: 83.0 parts
Pigment (Pigment Blue 15:3): 17.0 parts

The above-described materials were mixed together using a Henschel mixer. The mixture was melt-kneaded with a co-rotating twin-screw extruder having a heating temperature in the roll of 100° C. The resulting mixture was cooled and coarsely ground to obtain coarsely ground toner particles.

Next, 80.0 parts of a simple liquid paraffin (trade name: Moresco White P-60, available from Moresco Corp.), 20.0 parts of the coarsely ground toner particles, and 0.08 parts of a polymer dispersant (amine value: 160 mgKOH/g) prepared by the graft polymerization of a 12-hydroxystearic acid condensate (average degree of condensation: 3.9) onto a dispersant (weight-average molecular weight: 6,000) having a polyethyleneimine framework were mixed together using a sand mill for 72 hours to prepare toner particle dispersion 21.

Then 2.4 parts of the compound represented by formula (1), where R¹ and R² are each a linear alkyl group having 4 carbon atoms, was added thereto to prepare liquid developer 21. The toner particles in liquid developer 21 had a volume-average particle diameter of 0.71 μm. The volume resistivity of liquid developer 21 was 2.7×10¹¹ Ω·cm and rated Rank D.

Liquid developer 21 did not electrophorese at all. It was not possible to measure the electrophoretic mobility of the toner. The electrophoretic mobility was rated Rank E. It was not possible to perform the development on the photosensitive drum. The dot reproducibility was rated Rank E.

### Comparative Example 4

### Production of Liquid Developer 22

Polymer A1: 83.0 parts
Pigment (Pigment Blue 15:3): 17.0 parts

The above-described materials were mixed together using a Henschel mixer. The mixture was melt-kneaded with a co-rotating twin-screw extruder having a heating temperature in the roll of 100° C. The resulting mixture was cooled and coarsely ground to obtain coarsely ground toner particles.

Next, 80.0 parts of a simple liquid paraffin (trade name: Moresco White P-60, available from Moresco Corp.), 20.0 parts of the coarsely ground toner particles, and 2.4 parts of a polymer dispersant (amine value: 160 mgKOH/g) prepared by the graft polymerization of a 12-hydroxystearic acid condensate (average degree of condensation: 3.9) onto a dispersant (weight-average molecular weight: 6,000) having a polyethyleneimine framework were mixed together using a sand mill for 72 hours to prepare toner particle dispersion 22.

Then 0.001 parts of the compound represented by formula (1), where R¹ and R² are each a linear alkyl group having 22 carbon atoms, was added thereto to prepare liquid developer 22. The toner particles in liquid developer 22 had a volume-average particle diameter of 0.73 μm. The volume resistivity of liquid developer 22 was 3.1×10¹¹ Ω·cm and rated Rank D.

Liquid developer 22 did not electrophorese at all. It was not possible to measure the electrophoretic mobility of the toner. The electrophoretic mobility was rated Rank E. It was not possible to perform the development on the photosensitive drum. The dot reproducibility was rated Rank E.

### Comparative Example 5

### Production of Liquid Developer 23

Polymer A1: 83.0 parts
Pigment (Pigment Blue 15:3): 17.0 parts

The above-described materials were mixed together using a Henschel mixer. The mixture was melt-kneaded with a co-rotating twin-screw extruder having a heating temperature in the roll of 100° C. The resulting mixture was cooled and coarsely ground to obtain coarsely ground toner particles.

Next, 80.0 parts of a simple liquid paraffin (trade name: Moresco White P-60, available from Moresco Corp.), 20.0 parts of the coarsely ground toner particles, and 0.08 parts of a polymer dispersant (amine value: 160 mgKOH/g) prepared by the graft polymerization of a 12-hydroxystearic acid condensate (average degree of condensation: 3.9) onto a dispersant (weight-average molecular weight: 6,000) having a polyethyleneimine framework were mixed together using a sand mill for 72 hours to prepare toner particle dispersion 23.

Then 2.4 parts of hydrogenated lecithin (trade name: Lecinol S-10, available from Nikko Chemicals Co., Ltd.) was added thereto to prepare liquid developer 23. The toner particles in liquid developer 23 had a volume-average particle diameter of 0.74 μm. The volume resistivity of liquid developer 23 was 6.5×Ω·cm and rated Rank E. The electrophoretic mobility of the toner in liquid developer 23 was 2.2×10⁻¹⁰ m²/V·s and rated Rank D.

The dot reproducibility of liquid developer 23 was inferior to those of Examples 1 to 18. No dots were recognizable. The dot reproducibility was rated Rank E.

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2019-140185, filed Jul. 30, 2019, which is hereby incorporated by reference herein in its entirety.

What is claimed is:

1. A liquid developer, comprising:
toner particles containing a binder resin and a colorant;
a liquid carrier;
a toner-particle dispersant; and
a compound represented by formula (1),
the liquid carrier containing at least one compound selected from the group consisting of liquid aliphatic hydrocarbons and liquid polysiloxanes,
the toner-particle dispersant being an amine-based dispersant: 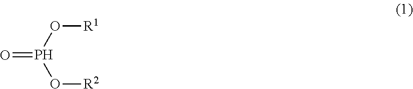
where in formula (1), R¹ and R² are each independently an alkyl group having 6 to 20 carbon atoms.

2. The liquid developer according to claim 1, wherein the compound represented by formula (1) is contained in the liquid developer in an amount of 0.01 to 10 parts by mass based on 100 parts by mass of the toner particles.

3. The liquid developer according to claim 1, wherein the toner-particle dispersant is an amine-based dispersant having a polyethyleneimine framework or a polyallylamine framework, and
wherein the toner-particle dispersant has an amine value of 2 to 150 mgKOH/g.

4. The liquid developer according to claim 1, wherein the toner-particle dispersant is contained in the liquid developer in an amount of 0.01 to 10 parts by mass based on 100 parts by mass of the toner particles.

5. The liquid developer according to claim 1, wherein the compound represented by formula (1) is contained in the liquid developer in an amount of 1 to 2,000 parts by mass based on 100 parts by mass of the toner-particle dispersant.

6. The liquid developer according to claim 1, wherein the liquid carrier contains a liquid isoparaffin.

7. The liquid developer according to claim 1, wherein R¹ and R² in formula (1) are each an alkyl group having 8 carbon atoms.

8. An image-forming apparatus, comprising:
an electrophotographic photosensitive member; and
a liquid developer that develops an electrostatic latent image to be formed on the electrophotographic photosensitive member,
the liquid developer containing:
toner particles containing a binder resin and a colorant;
a liquid carrier;
a toner-particle dispersant; and
a compound represented by formula (1),
the liquid carrier containing at least one compound selected from the group consisting of liquid aliphatic hydrocarbons and liquid polysiloxanes,
the toner-particle dispersant being an amine-based dispersant: 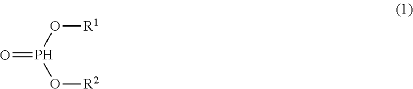
where in formula (1), R¹ and R² are each independently an alkyl group having 6 to 20 carbon atoms.
